(19) United States
(12) Patent Application Publication
(10) Pub. No.: US 2017/0352001 A1
(43) Pub. Date: Dec. 7, 2017

(54) HIGHLY AUTOMATED SHIPPING LOGISTICS EVENT TRACKING USING CONTEXT-SPECIFIC REMINDER TEMPLATES

(71) Applicant: Transfair North America International Freight Services, Inc., Seattle, WA (US)

(72) Inventors: Jonathan ISENBERG, Lake Tapps, WA (US); Greg VERNOY, Seattle, WA (US); Sean BRANDENBURG, Kent, WA (US)

(21) Appl. No.: 15/174,927

(22) Filed: Jun. 6, 2016

(51) Int. Cl. G06Q 10/08

(52) U.S. Cl. CPC G06Q 10/0833; G06Q 10/087

(57) ABSTRACT

Methods and systems are presented for facilitating a succession of transport projects each having a primary transport mode and other contextual attributes by providing many context-specific task definitions associated with that project, defining attributes of programmatic reminders associated with those task definitions, and by providing various “reminder” and “no reminder” default settings that a scheduling specialist can toggle. This expedites data entry, reduces errors, and allows for more effective institutional retention of best shipping practices.

### FIELD

This disclosure relates to intelligence amplification in the field of shipping logistics, classifiable in US Class 705, Subclass 333.

### BRIEF DESCRIPTION OF THE DRAWINGS

FIG. 1 depicts a system with a server and several client devices.

FIG. 2 depicts an image signifying a “domestic” transport project.

FIG. 3 depicts parametric input relating to a transport project.

FIG. 4 depicts tabular data comprising various templates usable for describing a transport project being created.

FIG. 5 depicts a task definition including various components.

FIG. 6 depicts timeline of a transport project featuring a ship crossing the Pacific Ocean.

FIG. 7 depicts an illustrated sequence of communications between a server and some client devices.

FIG. 8 depicts an image signifying an “ocean import” transport project in its default state.

FIG. 9 depicts the transport project of FIG. 8 in a modified state.

FIG. 10 depicts an image signifying an “air import” transport project in its default state.

FIG. 11 depicts the transport project of FIG. 10 in a modified state.

FIG. 12 illustrates many modules of transistor-based circuitry, optionally implemented as an ASIC.

FIG. 13 illustrates additional transistor-based circuitry, including a timer.

FIG. 14 illustrates a client device like those of FIGS. 1 and 7.

FIG. 15 illustrates a server like that of FIGS. 1 and 7.

FIG. 16 illustrates an event tracking routine suitable for use with at least one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote database servers, computer servers and memory storage devices.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Action-specific,” “being,” “concerning,” “finally,” “first,” “having,” “least,” “partly,” “received,” “related,” “said,” “second,” “toggled,” “transistor-based,” “unmodified,” “user-switchable,” “with,” “wherein,” or other such descriptors herein are used in their normal yes-or-no sense, not as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures. As used herein, the term “contemporaneous” refers to circumstances or events that are concurrent or at least roughly contemporaneous (on the same day, e.g.).

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

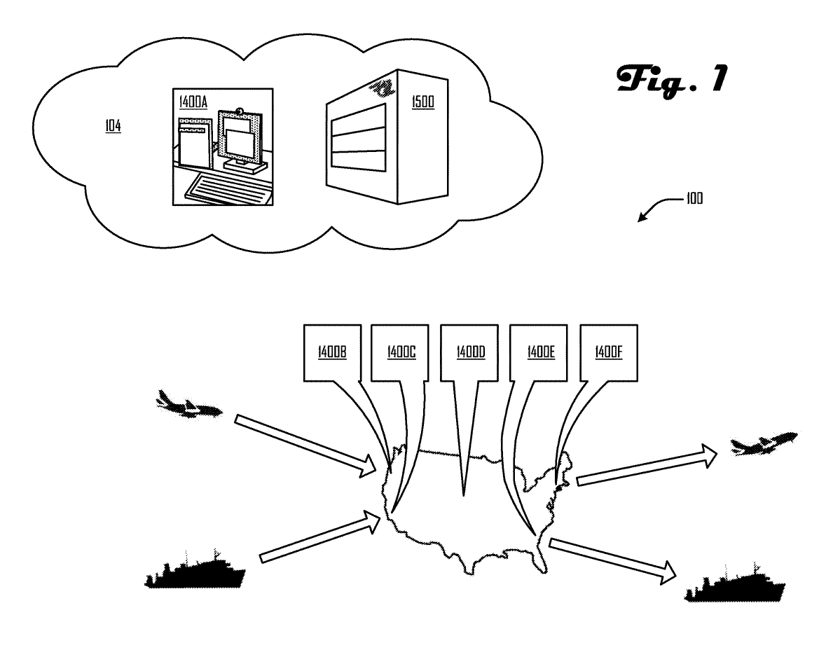

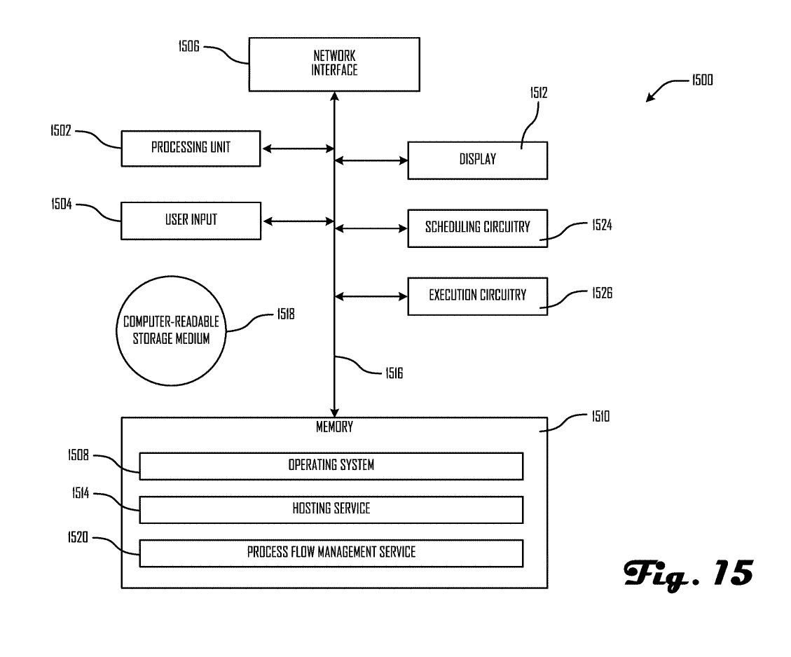

FIG. 1 depicts a system in which one or more technologies may be implemented. A server 1500 implements various intelligence amplification protocols as described below, especially in regard to FIGS. 7 and 15. System 100 is tailored to streamline various computer processes, especially data input and retention, to facilitate successful shipping projects at scale. One or more users of client device 1400A within network 104 receive reminders from server 1500, which is also operably coupled to one or more other client devices 1400B-F that may program the reminders. As used herein, a “reminder” may include a programmatically delayed digital notification to one or more human users (by email or via special-purpose mobile hardware, e.g.) concerning a confirmatory or upcoming action. The shipment to which each action pertains is generally in one of five categories: air import, sea import, domestic, sea export, or air export.

FIG. 2 depicts an image 200 signifying a “Domestic” transport project in which many reminder configuration records 240A-B each refer to an action to which a scheduled reminder will pertain. Each such record 240 includes a label 244 that manifests the action descriptively enough to allow someone familiar with domestic shipments to determine whether a reminder of that record will be appropriate for a particular project; a basis 246 upon which a reminder time for that record is to be computed; an offset or other operand that may affect the corresponding time indicator; and a toggle setting 243 that enables the reminder if it is set to one Boolean value (“REMIND,” e.g.) and that can be toggled to an opposite Boolean value (to disable that reminder without deleting it, e.g.).

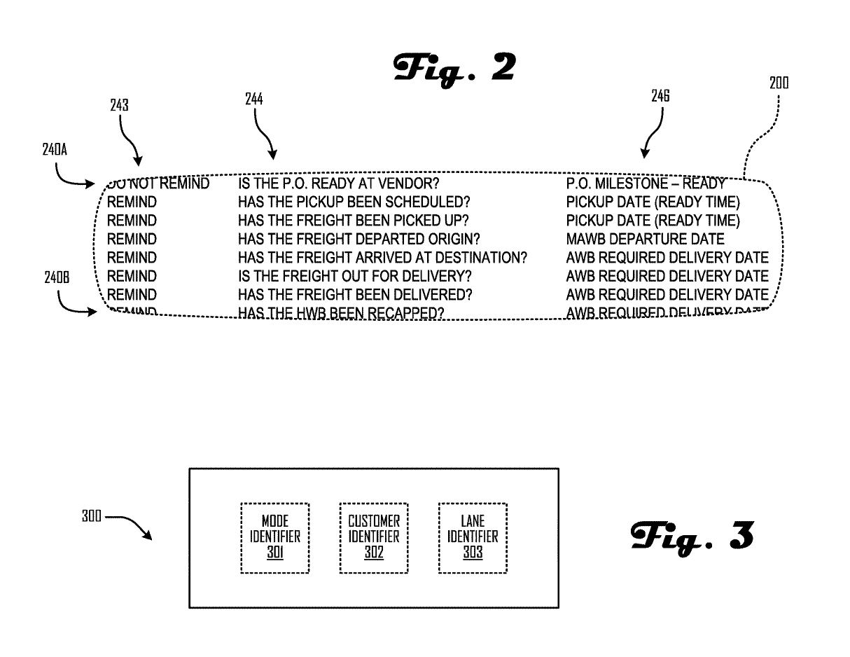

FIG. 3 depicts parametric input 300 that may affect which template described below is most applicable to a project being created. Such input 300 may include one or more instances of mode identifiers 301, of customer identifiers 302, or of lane identifiers 303. A given shipment may be known, for example, to have a transport mode of “Ocean Import” or “By Boat,” for example. Additionally, the context-descriptive parametric input 300 may including a particular customer identifier 302 (identifying “Acme Corporation,” e.g.) or a particular lane identifier 303 (identifying a Shanghai-to-Los-Angeles shipment, e.g.) pertaining to the shipment.

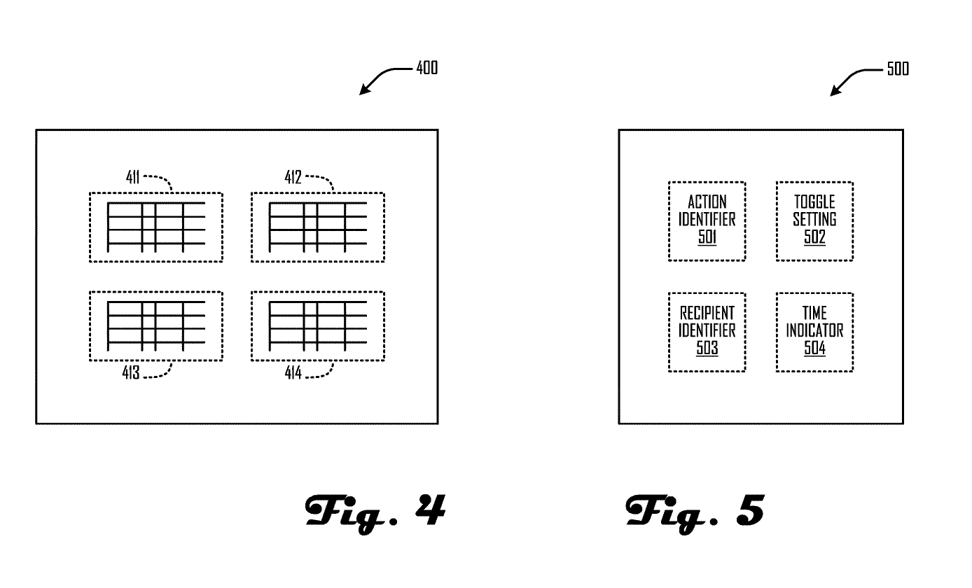

FIG. 4 depicts tabular data 400 comprising various templates 411-414 potentially usable for describing a project being created. One is a lane-specific, customer-specific template 411. Another is a customer-generic, lane-specific template 412. Another is a lane-generic, customer-specific template 413. And another is a mode-specific template 414. Any of these four types of templates may be specific to each transport mode identifier 301, as further described below. In some variants, moreover, some such templates (referred to as a “filter” herein) may supersede selected components of a primary template.

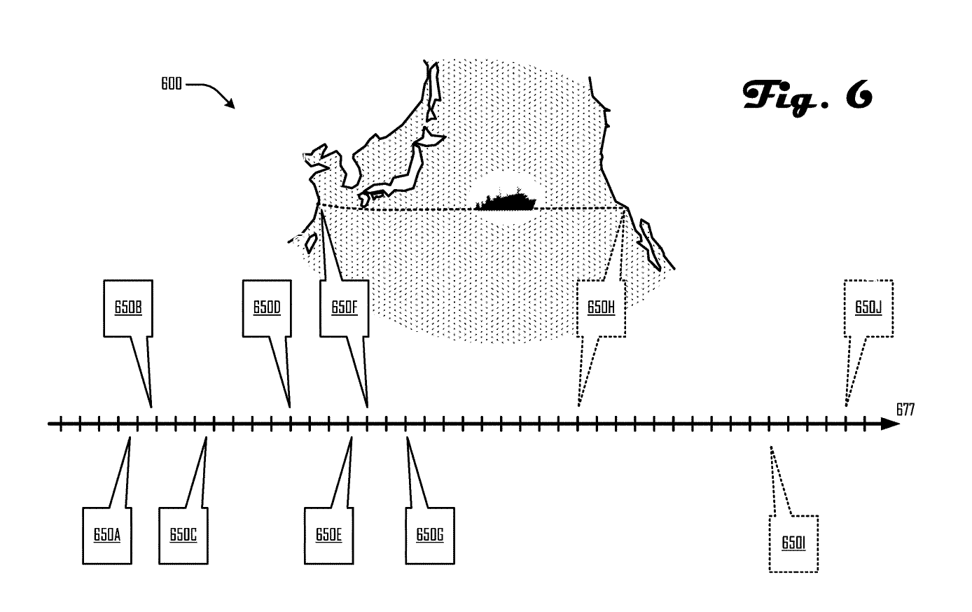

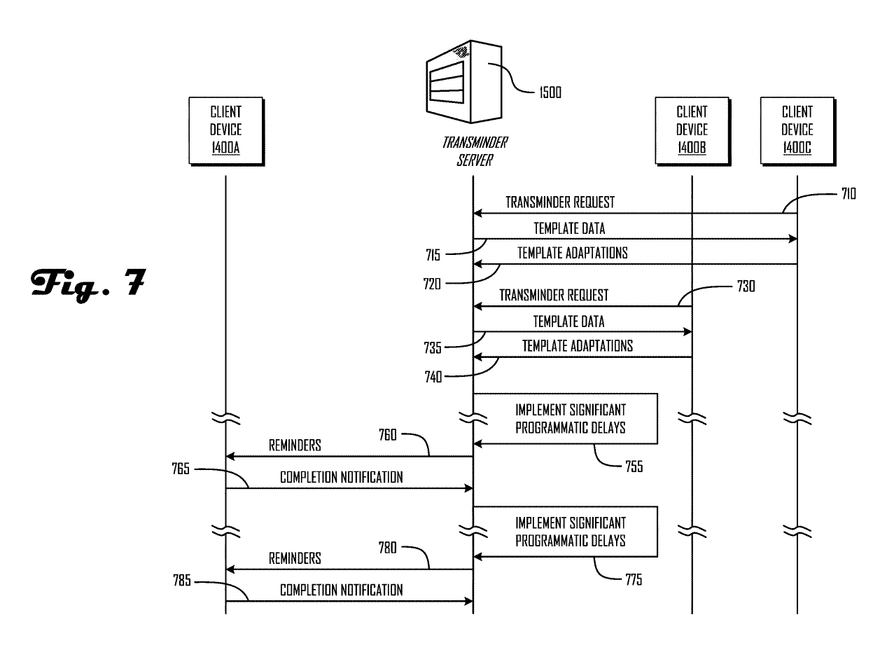

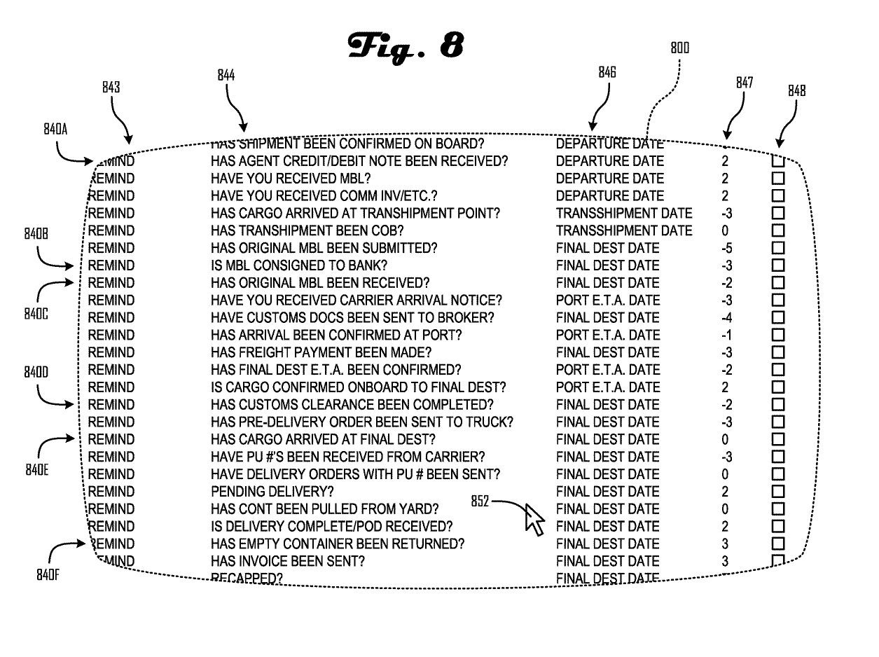

FIG. 5 depicts a task definition 500 including one or more instances of action identifiers 501, of toggle settings 502, of recipient identifiers 503, or of time indicators 504. As used herein, an “action” may refer both to a thing done (or to be done) and to a digital identifier of that thing (as an alphanumeric character sequence, e.g.). A “time” may likewise specify when a reminder is to occur that is unique in context, even if it is expressed as a term (like “tomorrow” or “noon Pacific Time” or “noon tomorrow Pacific Time,” e.g.) that does not explicitly state the (date and) time in full quantitative terms. And in FIGS. 8-11, reminder times are expressed in terms of a known event time and a numerical operand with which it is combined to express each time uniquely as a formula.

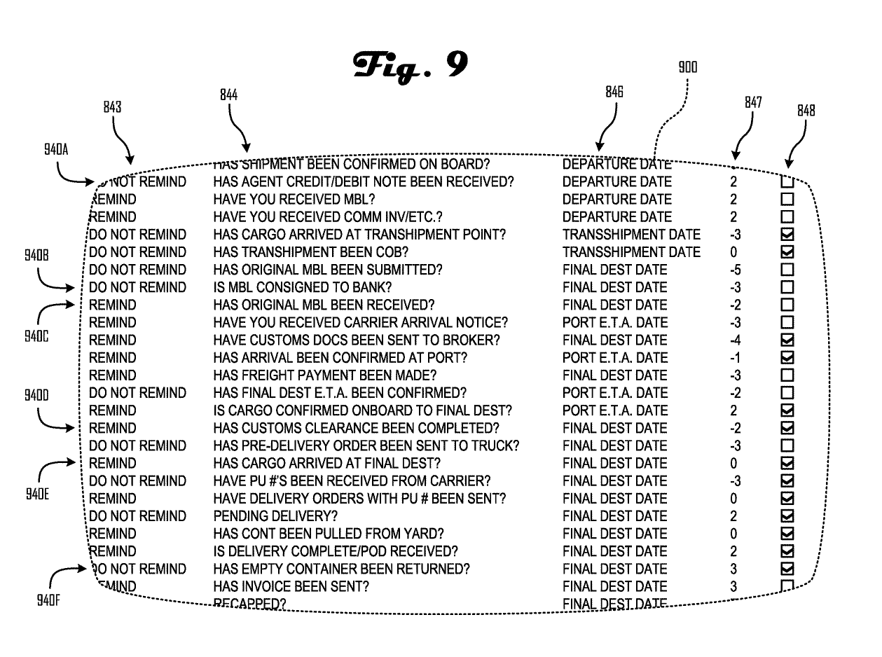

FIG. 6 depicts an event sequence 600 in progress (for an “Ocean Import” transport project from Shanghai to Los Angeles, e.g.) in which a mode identifier 301 signals a transport-by-boat shipment. A timeline 677 is shown having one-day increments and multiple racked milestone times 650A-J. At a first tracked time 650A in mid-May, an Estimated Time of Arrival (ETA) time 650H of June 11 was filled out. At another tracked time 650B about a day later, server 1500 (as depicted in one or more of FIGS. 1, 7 and 15) sent a booking-confirmed reminder that reminded the recipient that a booking needed to be confirmed within a few days (by tracked time 650C, e.g.). At another tracked time 650D several days after that, server 1500 sent a shipment-confirmed-on-board reminder (see FIG. 9) indicating that the shipment needed to be confirmed on board (COB) within the next four days (by tracked time 650E, e.g.). The departure time 650F (signifying when the shipment actually left Shanghai, e.g.) occurred about June 1, and server 1500 sends a Master Bill of Lading (MBL) receipt-confirmation reminder two days later at time 650G.

All of the foregoing times 650A-G on timeline 677 are “actual” dates partway through the voyage, as shown. Subsequent times 650H-J are shown before-the-fact and are accordingly shown with dashed lines. Many more actions occur in this period and appropriate reminders are sent, as detailed more fully with regard to FIG. 9. About ten days after the ETA time 650H of June 11, one or more regulatory-hold-confirmation reminders (pertaining to the United States Department of Agriculture or the Food and Drug Administration, e.g.) are to be sent, at time 6501. Four days later the corresponding action is due, at time 650J. This can occur, for example, in a context in which timely reminders are critical because early reminders are not actionable and because late actions trigger significant penalties.

FIG. 7 depicts an illustrated sequence of communications between TransMinder server 1500 and some of the client devices 1400A-C depicted FIG. 1. As a real-time or other response to a TransMinder request 710 from a user of client device 1400C requesting a creation of a template for use in a sea-import-type project, server 1500 sends suitable template data 715. After each of several user inputs via client device 1400C, server 1500 receives template adaptations 720 that are then stored at server 1500. Likewise in response to a TransMinder request 730 from a user of client device 1400B requesting a creation of a template for use in an air-import-type project, server 1500 sends suitable template data 735. After each of several user inputs via client device 1400B, server 1500 receives template adaptations 740 that are then stored at server 1500.

Having completed the scheduling, server 1500 now executes its litany of programmatic reminders. After significant programmatic delays 755 (of days or weeks, e.g.) with appropriate and necessary precision, server 1500 sends many well-timed reminders 760 to a client device 1400A used by a reminder recipient about necessary actions that do not appear to be complete yet. Many of these actions are performed by one or more reminder recipients without any access to the users who programmed the reminders with severe consequences for late performance and no advantage for early notification. The reminder recipient completes actions to which the reminders pertain and sends a corresponding completion notification 765 back to server 1500. Notification are disabled for actions that are marked as complete. See FIG. 9.

Following additional programmatic delays 775 (of days or weeks, e.g.) with appropriate and necessary precision, server 1500 again sends many well-timed reminders 780 to client device 1400A about necessary actions that do not appear to be complete yet. Again the reminder recipient(s) complete(s) actions to which the reminders pertain and sends a corresponding completion notification 785 back to server 1500. Notification are disabled for actions that are marked as complete.

FIG. 8 depicts an image 800 signifying an “Ocean Import” transport project in which many reminder configuration records 840A-F each defining a task relating to a mode identifier 301 of “Ocean Import” are depicted. Each such record 840 includes a label 844 that manifests an action descriptively enough to allow someone familiar with ocean transport projects to determine whether a reminder of that record will be appropriate for a particular project; a basis 846 upon which a reminder time (expressed as an instance of time indicator 504, e.g.) for that record is to be computed; an operand 847 that may be used to determine the corresponding time indicator 504 (expressing as an offset signifying a number of days after the basis the reminder should occur, e.g.); an action status 848 (being checked only for completed actions, e.g.); and a toggle setting 843 that enables the reminder if it is set to one Boolean value (“REMIND,” e.g.) and that can be toggled to an opposite Boolean value to disable that reminder without deleting it. (Date values of the initial bases 846 for each record 840 are, for present purposes, known and adjustable by the reminder recipient to reflect an updated context as the shipment progresses.)

The default template for image 800 as shown has all of the toggle settings 843 set to “REMIND” and all of the action statuses 848 unchecked (signaling not being completed yet, e.g.). This corresponds with a by-boat-specific template 414 in its just-copied state (before time 650A as shown on FIG. 6, e.g.). But the user can change any or all of these and the reminder recipient can change at least the action statuses 848, either of which changes will disable a reminder for the action of its corresponding record 840.

For example for an action of “HAS AGENT CREDIT/DEBIT NOTE BEEN RECEIVED?” as shown, a user can retain but disable the corresponding reminder of that task definition by (guiding cursor 852 to the toggle setting 843 of record 840A and) toggling “REMIND” to indicate “DO NOT REMIND” instead.

Likewise for an action of “IS MBL CONSIGNED TO BANK?” (concerning a Master Bill of Lading, e.g.) as shown, a user can retain but disable the corresponding reminder of that task definition by (toggling setting 843 of record 840B and) toggling “REMIND” to indicate “DO NOT REMIND” instead.

Likewise for an action of “HAS ORIGINAL MBL BEEN RECEIVED?” as shown, a user can retain but disable the corresponding reminder of that task definition by (toggling setting 843 of record 840C and) toggling “REMIND” to indicate “DO NOT REMIND” instead. If the user has second thoughts on this change, the user can toggle that setting again, back to “REMIND.” This can occur, for example, in a context in which a user who has such second thoughts frequently would otherwise waste significant energy re-creating deleted reminders.

Likewise for an action of “HAS CUSTOMS CLEARANCE BEEN COMPLETED?” as shown, a user can retain the corresponding reminder of that task definition (by toggling the setting 843 of that record 840D an even number of times, e.g.). In some variants the user can likewise adjust the operand 847 for that record 840D, but in the absence of such changes server 1500 will transmit a customs-clearance-reminder two days before the (scheduled or actual) “final destination date” because the operand 847 is set to -2.

Likewise for an action of “HAS CARGO ARRIVED AT FINAL DEST?” as shown, a user can retain the corresponding reminder of that task definition (by not toggling the setting 843 of that record 840E, e.g.). In some variants the user can likewise adjust the operand 847 for that record 840D, but in the absence of such changes server 1500 will transmit an arrival-verification-reminder on the “final destination date” because the operand 847 is set to zero.

Likewise for an action of “HAS EMPTY CONTAINER BEEN RETURNED?” as shown, a user can disable the corresponding reminder of that task definition (by toggling the setting 843 of that record 840F, e.g.) if desired. In the absence of such changes server 1500 will transmit a confirm-container-returned-reminder 3 days after the “final destination date” because the operand 847 is set to 3.

FIG. 9 depicts an image 900 signifying the “Ocean Import” transport project of FIG. 8 in which a user has disabled several reminders by flipping their toggle settings 843 to “DO NOT REMIND.” Also action statuses of many of the records 840 have been checked, signifying that the action has been completed. Several of the particular records 940A-F shown in image 900 effectively signify an updated version of corresponding records 840A-F of FIG. 8. Image 900 also serves as a concise summary of which actions do not require a reminder (corresponding to record 940B, e.g.), which actions will apparently require a reminder (corresponding to record 940C, e.g.), which actions stand completed (including those corresponding to record 940D, e.g.), and which reminders have been disabled without regard to completion (including record 940F, e.g.) all in a single screen image.

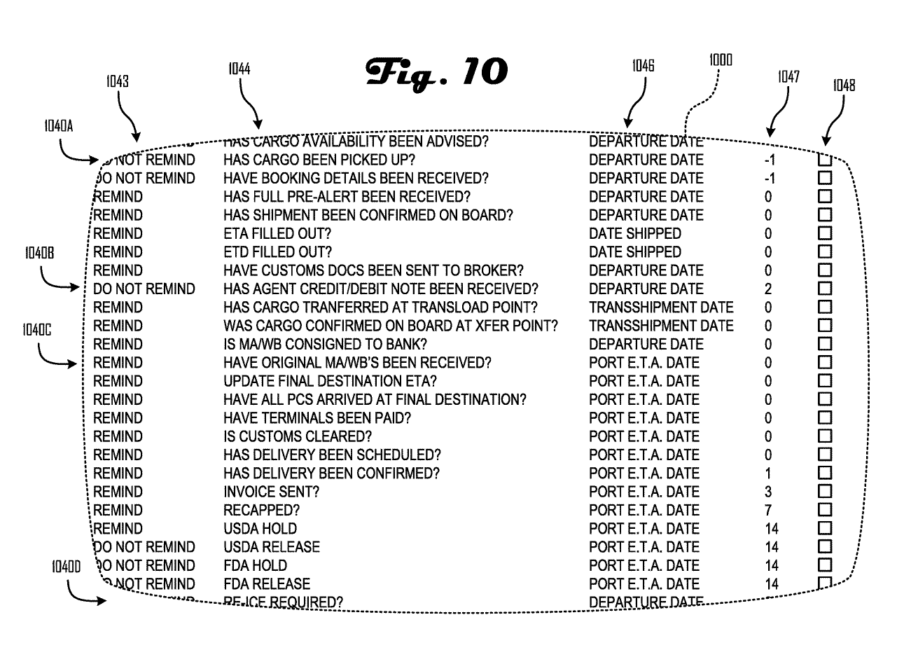

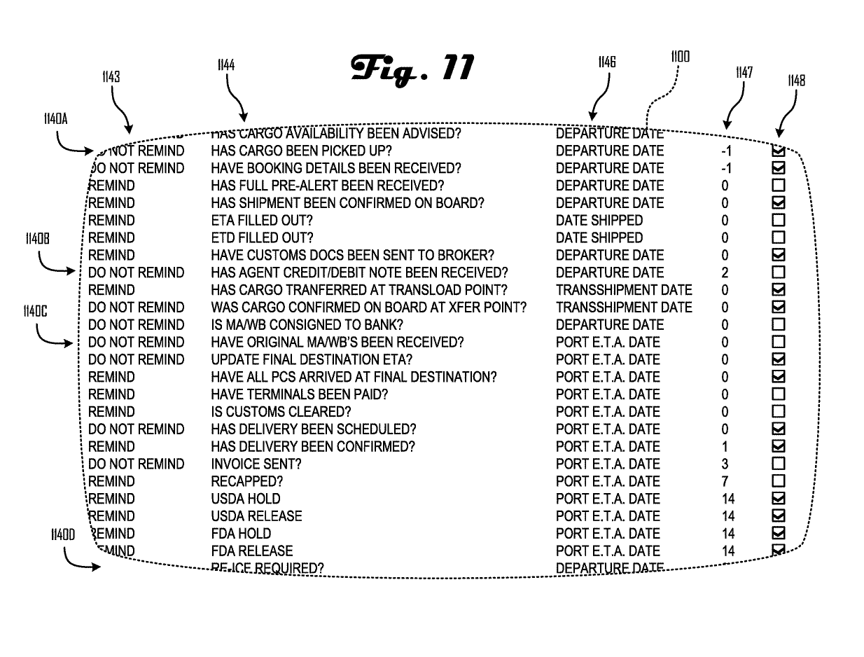

FIG. 10 depicts an image 1000 signifying an “Air Import” transport project in which many reminder configuration records 1040A-D each defining a task relating to a mode identifier 301 of “Air Import” are depicted. Each such record 1040 includes a label 1044 that manifests an action descriptively enough to allow someone familiar with air transport projects to determine whether a reminder of that record will be appropriate for a particular project; a basis 1046 upon which a reminder time (expressed as an instance of time indicator 504, e.g.) for that record is to be computed; an operand 1047 that may be used to determine the corresponding time indicator 504 (expressing as an offset signifying a number of days after the basis the reminder should occur, e.g.); an action status 1048 (being checked only for completed actions, e.g.); and a toggle setting 1043 that enables the reminder if it is set to one Boolean value (“DO NOT REMIND,” e.g.) and that can be toggled to an opposite Boolean value to enable that reminder without necessarily needing to create it. (Date values of the initial bases 1046 for each record 1040 are, for present purposes, known and adjustable by the reminder recipient to reflect an updated context as the shipment progresses.)

The default template for image 1000 as shown has some of the toggle settings 1043 set to “REMIND,” and some not, and all of the action statuses 1048 unchecked (signaling not being completed yet, e.g.). This corresponds with a by-air-specific template 414 in its just-copied state (before any tracked actions of the project are complete, e.g.). But the user can change any or all of these and the reminder recipient can change at least the action statuses 1048.

For example for an action of “HAS CARGO BEEN PICKED UP?” as shown in record 1040A, a user can enable the corresponding reminder of that task definition by toggling “DO NOT REMIND” to indicate “REMIND” instead. Likewise for an action of “HAS AGENT CREDIT/DEBIT NOTE BEEN RECEIVED?” as shown in record 1040B, a user can enable the corresponding reminder of that task definition by toggling “DO NOT REMIND” to indicate “REMIND” instead.

Conversely for an action of “HAVE ORIGINAL MA/WB'S BEEN RECEIVED?” (in regard to a Master Air Waybill, e.g.) as shown in record 1040C, the initial default value is “REMIND.” Therefore user can disable the corresponding reminder of that task definition by toggling “REMIND” to indicate “DO NOT REMIND” instead without deleting the task definition. This enables the user to toggle between these complementary Boolean values at will, without affecting any other components of the record 104C of which they are a part.

And for an action of “RE-ICE REQUIRED?” (in regard to a perishable shipment kept cold by ice that may need replacement, e.g.) as shown in record 1040D, the initial default value is “DO NOT REMIND.” Therefore user can enable the corresponding reminder of that task definition by toggling “DO NOT REMIND” to indicate “REMIND” instead.

FIG. 11 depicts an image 1100 signifying the “Air Import” transport project of FIG. 10 in which a user has disabled several reminders that are “on” by default by toggling settings 1043 (toggling record 1040C and other records as shown from “REMIND” to “DO NOT REMIND,” e.g.). The user has likewise enabled several reminders that are “off” by default by toggling settings 1043 (toggling record 1040D and other records as shown from “DO NOT REMIND” to “REMIND,” e.g.). Also in FIG. 11 action statuses 1048 of many of the records 1040 have been checked, signifying that the action has been completed. Several of the particular records 1140A-D shown in image 1100 effectively signify an updated version of corresponding records 1040A-D of FIG. 10. Image 1100 also serves as a concise summary of which actions do not require a reminder (corresponding to records 1140B and 1140C, e.g.) and which actions stand completed (including those corresponding to record 1140A, e.g.) all in a single screen image.

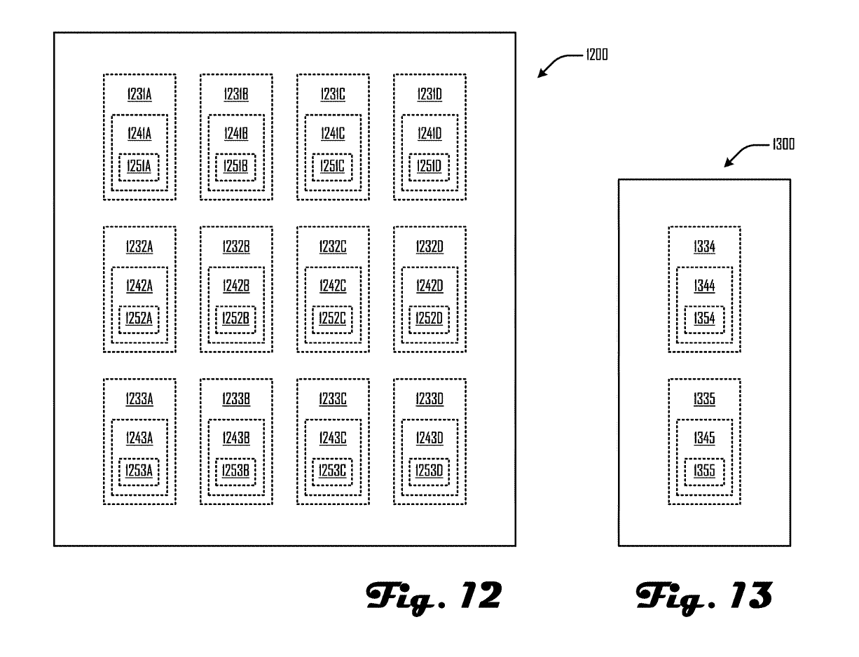

FIG. 12 illustrates special-purpose transistor-based circuitry 1200—optionally implemented as an Application-Specific Integrated Circuit (ASIC), e.g.—in which some or all of the functional modules described below may be implemented. Transistor-based circuitry 1200 is an event-sequencing structure generally as described in U.S. Pat. Pub. No. 20150094046 but configured as described herein. Transistor-based circuitry 1200 includes one or more instances of interface modules 1231A-D, for example, each including an electrical node set 1241A-D upon which Boolean results or other informational data is represented digitally as a corresponding voltage configuration 1251A-D.

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any records or other informational data identified herein may easily be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data.

Transistor-based circuitry 1200 further includes one or more instances of duplication modules 1232A-D, for example, each including an electrical node set 1242A-D (of one or more nodes) upon which a user-switchable setting or other informational data is represented digitally as a corresponding voltage configuration 1252A-D as shown. Transistor-based circuitry 1200 further includes one or more instances of update modules 1233A-D, for example, each including an electrical node set 1243A-D upon which user input or other informational data is represented digitally as a corresponding voltage configuration 1253A-D as shown. In some variants, as described below in the clauses and claims, such a module implements such functionality jointly (in conjunction with other modules or processing units described herein, e.g.).

FIG. 13 illustrates special-purpose transistor-based circuitry 1300—optionally implemented as a component of an ASIC or server 1500, e.g.—in which some or all of the functional modules described herein may be implemented. Transistor-based circuitry 1300 includes one or more instances of a timer 1334, including an electrical node set 1344 upon which a current time is represented digitally as a corresponding voltage configuration 1354 as shown. Transistor-based circuitry 1300 may also include one or more instances of a comparator 1335, including an electrical node set 1345 upon which a comparison result as described herein is represented digitally as a corresponding voltage configuration 1355 as shown.

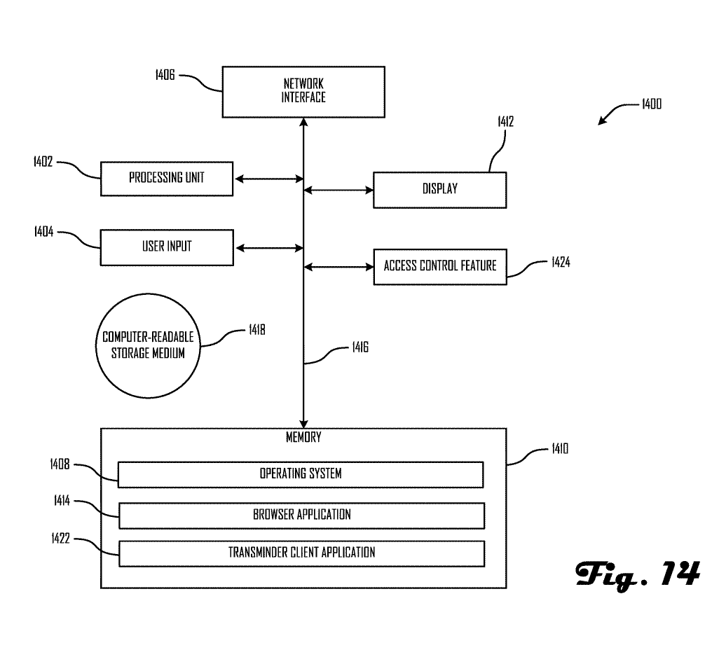

FIG. 14 illustrates a client device 1400 in which one or more technologies may be implemented. In respective embodiments, client device 1400 may be a general-purpose computer or may include special-purpose components. As shown in FIG. 14, exemplary client device 1400 includes one or more processing units 1402 in data communication with one or more memories 1410 via one or more buses 1416. Each such memory 1410 generally comprises some or all of random access memory (RAM), read-only memory (ROM), or a permanent mass storage device, such as a disk drive, flash memory, or the like. Client device 1400 may also include one or more instances of network interfaces 1406, of user inputs 1404, of displays 1412, or of speakers.

As shown, memory 1410 of exemplary client device 1400 may store an operating system 1408, as well as program code for a number of software applications, such as a browser application 1414 or TransMinder client application 1422. Browser application 1414 is a software application by which, under client device control, client devices 1400 can present data to users and transmit data from users. These and other software components, as well as various data files (not shown) may be loaded into memory 1410 via network interface 1406 (or via a selectively removable computer readable storage medium 1418, such as a memory card or the like).

In operation, operating system 1408 manages the hardware and software resources of the client device 1400 and provides common services for various software applications, such as browser application 1414. For hardware functions such as network communications via network interface 1406, obtaining data via user input 1404, rendering data via displays 1412 or speakers, allocation of memory 1410 to various resources, operating system 1408 may act as an intermediary between software executing on client device 1400 and the client device's hardware.

For example, operating system 1408 may cause a representation of locally available software applications, such as browser application 1414, to be rendered locally (via display 1412, e.g.). If operating system 1408 obtains, e.g. via user input 1404, a selection of browser application 1414, operating system 1408 may instantiate a browser application process (not shown), i.e. cause processing unit 1402 to begin executing the executable instructions of browser application 1414 and allocate a portion of memory 1410 for its use. In some contexts, downloads may require an access control feature 1424 configured to prevent unauthorized downloads and permit specially-configured client devices to access server 1500. Alternatively or additionally, some functions may occur “offline” in the sense that the client device 1400 is temporarily disconnected from server 1500.

Although an exemplary client device 1400 has been described, a client device 1400 may be a mobile device or other device capable of executing program code, such as the program code corresponding to browser application 1414. Alternatively or additionally, the structures described with reference to FIG. 14 may likewise be implemented by a special-purpose peer computer in a peer-to-peer network.

FIG. 15 illustrates a server 1500 in which one or more technologies may be implemented. As shown in FIG. 15, exemplary server 1500 includes one or more processing units 1502 in data communication with one or more memories 1510 via one or more buses 1516. Each such memory 1510 generally comprises some or all of random access memory (RAM), read-only memory (ROM), or a permanent mass storage device, such as a disk drive, flash memory, or the like. Server 1500 may also include one or more instances of network interfaces 1506, of user inputs 1504, of displays 1512, or of speakers (not shown).

As shown, memory 1510 of exemplary server 1500 may store an operating system 1508, as well as program code for a number of software applications, such as a hosting service 1514. Hosting service 1514 is a software application by which, under server control, client devices 1400 can present data to users and transmit data from users. These and other software components, as well as various data files (not shown) may be loaded into memory 1510 via network interface 1506 (or via a selectively removable computer readable storage medium 1518, such as a memory card or the like).

In operation, operating system 1508 manages the hardware and software resources of the server 1500 and provides common services for various software applications, such as hosting service 1514. For hardware functions such as network communications via network interface 1506, obtaining data via user input 1504, rendering data via displays 1512 or speakers, allocation of memory 1510 to various resources, and invoking one or modules of scheduling circuitry 1524, execution circuitry 1526, or other special-purpose circuitry, operating system 1508 may act as an intermediary between software executing on server 1500 and the server's hardware. Scheduling circuitry 1524 may, for example, include or otherwise invoke some or all of transistor-based circuitry 1200. Likewise execution circuitry 1526 may, for example, include or otherwise invoke some or all of transistor-based circuitry 1300.

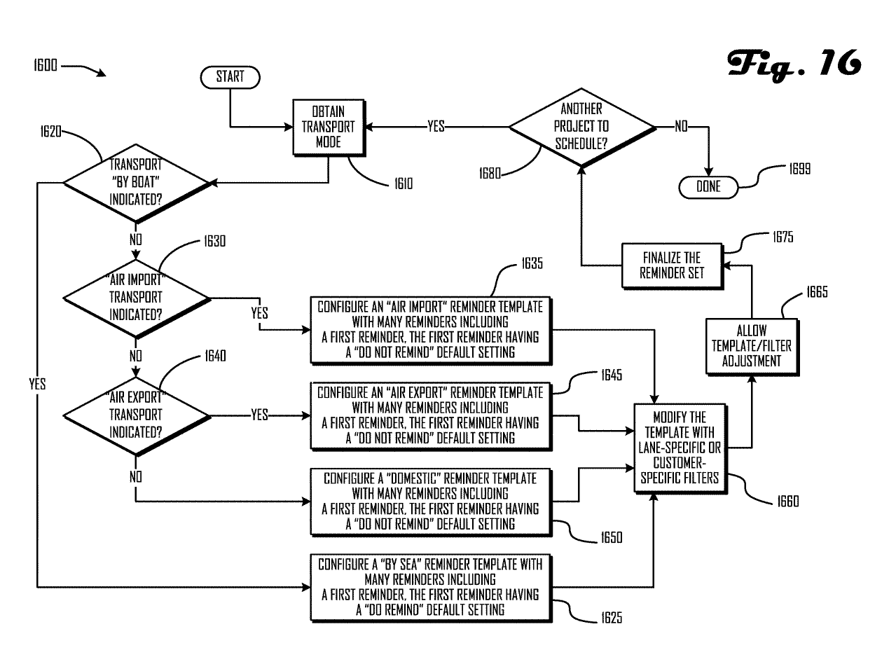

For example, operating system 1508 may cause a representation of locally available software applications, such as hosting service 1514, to be rendered locally (via display 1512, e.g.). If operating system 1508 obtains, e.g. via user input 1504, a selection of hosting service 1514, operating system 1508 may instantiate a hosting service process, i.e. cause processing unit 1502 to begin executing the executable instructions of hosting service 1514 and allocate a portion of memory 1510 for its use. Alternatively or additionally, operating system 1508 may instantiate a process flow management service 1520, including one or more operational sequences described herein (with regard to FIGS. 7 and 16, e.g.).

Although an exemplary server 1500 has been described, a server 1500 may be any of a great number of computing devices capable of executing program code, such as the program code corresponding to hosting service 1514. Alternatively or additionally, the structures described with reference to FIG. 15 may likewise be implemented by a special-purpose peer computer in a peer-to-peer network.

FIG. 16 illustrates an event tracking routine 1600 suitable for use with at least one embodiment, such as a server 1500 having special-purpose transistor-based circuitry 1200, 1300. As will be recognized by those having ordinary skill in the art, not all events of information management are illustrated in FIG. 16. Rather, for clarity, only those steps reasonably relevant to describing the shipping logistics event tracking aspects of routine 1600 are shown and described. Those having ordinary skill in the art will also recognize the present embodiment is merely one exemplary embodiment and that variations on the present embodiment may be made without departing from the scope of the broader inventive concept set forth in the clauses and claims below.

Following a start operation, execution block 1610 depicts obtaining a transport mode for a current shipping project (mode identifier 301 of FIG. 3, e.g.). This can occur, for example, in a context in which (an instance of) an update module 1233A that performs this operation contains an electrical node set 1243A upon which a voltage configuration 1253A manifests a (first instance of) mode identifier 301 (designating “Sea Import” or “Sea Export,” e.g.) provided via client device 1000C. Execution then proceeds to decision block 1620.

At decision block 1620, if the transport mode designates oceanic transport or the like, then event tracking routine 1600 proceeds to execution block 1625, described next. Otherwise event tracking routine 1600 proceeds to decision block 1630, described further down. This can occur, for example, in a context in which an interface module 1231A that obtains this decision contains an electrical node set 1241A upon which a voltage configuration 1251A manifests a Boolean determination (a high voltage on a particular electrical node indicating an affirmative result or a low voltage there indicating a negative result, e.g.) or other such digital expression.

Execution block 1625 depicts configuring an oceanic-transport-type reminder template with multiple reminder configuration records including a particular one record that has an initial default setting affirmatively signaling a reminder event. This can occur, for example, in a context in which (an instance of) a duplication module 1232A generates a user-editable copy of the appropriate template 1214 that can then be fully customized for the current shipping project with minimal data entry during setup, the duplication module 1232A containing an electrical node set 1242A upon which a voltage configuration 1252A manifests a (first instance of) a user-switchable setting 1502 (a value that can switch only between “YES” and “NO” as provided via client device 1000C or client device 1000E, e.g.); in which that (user-switchable reminder inclusion) setting signifies an affirmative default value of a confirm-container-returned task definition so that an appropriate reminder 4501 will occur shortly after a shipment using one or more leased shipping containers arrives at its destination and so that a penalty will not be incurred by virtue of a busy shipping agent forgetting to see to the empty shipping container(s) being returned promptly; and in which significantly more data entry would otherwise be required (starting from a fully acontextual template for each project e.g.). Execution then proceeds to execution block 1660.

At decision block 1630, if the transport mode designates an import by airplane or the like, then event tracking routine 1600 proceeds to execution block 1635, described next. Otherwise event tracking routine 1600 proceeds to decision block 1640, described further down. This can occur, for example, in a context in which an interface module 1231B that obtains this decision contains an electrical node set 1241B upon which a voltage configuration 1251B manifests a Boolean determination (a low voltage on a particular electrical node indicating an affirmative result or a high voltage there indicating negative result, e.g.) or other such digital expression.

Execution block 1635 depicts configuring an airplane-import-transport-type reminder template with multiple reminder configuration records including a particular one record that has several parameters one of which is an initial default setting signaling negatively, signifying that no reminder event will occur for that action. This can occur, for example, in a context in which (an instance of) a duplication module 1232B generates a user-editable copy of the appropriate template 1214 that can then be fully customized for the current shipping project with minimal data entry during setup, the duplication module 1232B containing an electrical node set 1242B upon which a voltage configuration 1252B manifests a (first instance of) a user-switchable setting 1502 (a value that can switch only between two values as provided via client device 1000B, e.g.); in which that (user-switchable reminder inclusion) setting signifies a negative default value of a confirm-re-ice-status task definition so that an appropriate reminder 450 will not, by default, be schedule to occur; in which a busy scheduling agent manages to program a suitable ice-replacement reminder nonetheless (just by flipping the user-switchable reminder inclusion setting 1502 of the confirm-re-ice-status task definition from “DO NOT REMIND” to “REMIND,” e.g.); in which a busy shipping agent is reminded to see to the ice-replacement action at an appropriate moment before or during the shipment so that a perishable shipment is not destroyed; and in which significantly more data entry would otherwise be required (starting from a fully acontextual template for each project e.g.).

In some variants another such voltage configuration 1252B manifests a second instance of user-switchable setting 1502 (of a confirm-terminal-paid task definition, e.g.). This instance of setting 1502 has an affirmative default value so that an appropriate reminder 450 will, by default, be schedule by the busy scheduling agent not toggling the user-switchable setting 1502; in which a timely reminder occurs so that the busy shipping agent is reminded at the appropriate time to make one or more timely payments so that non-payment penalties and delays of future shipments are avoided; and in which significantly more data entry would otherwise be required for appropriately configuring the many reminders required for each successful shipment. Following execution block 1635, execution then proceeds to execution block 1660.

At decision block 1640, if the transport mode designates an export by airplane or the like, then event tracking routine 1600 proceeds to execution block 1645, described next. Otherwise event tracking routine 1600 proceeds to execution block 1650, described further down. This can occur, for example, in a context in which an interface module 1231C that obtains this decision contains an electrical node set 1241C upon which a voltage configuration 1251C manifests a Boolean determination (a “11” signifying a pair of high voltages on two particular electrical nodes indicating an affirmative answer or other voltage configurations there indicating a negative answer, e.g.) or other such digital expression.

Execution block 1645 depicts configuring an airplane-export-transport-type reminder template with multiple reminder configuration records including a particular one record that has several parameters one of which is an initial default setting signaling negatively, signifying that no reminder event will occur for that action. This can occur, for example, in a context in which (an instance of) a duplication module 1232C generates a user-editable copy of the appropriate template 1214 that can then be fully customized for the current shipping project with minimal data entry during setup, the duplication module 1232C containing an electrical node set 1242C upon which a voltage configuration 1252C manifests a (first instance of) a user-switchable setting 1502 (a value that can switch only between “DO NOT REMIND” and “REMIND” as provided via client device 1000F, e.g.); and in which significantly more data entry would otherwise be required (starting from a fully acontextual template for each project e.g.). Execution then proceeds to execution block 1660.

Execution block 1650 depicts configuring a domestic-transport-type reminder template with multiple reminder configuration records including a particular one record that has several parameters one of which is an initial default setting signaling affirmatively, signifying that a reminder event will occur for that action unless a user modifies it. This can occur, for example, in a context in which (an instance of) a duplication module 1232A generates a user-editable copy of the appropriate template 1214 that can then be fully customized for the current shipping project with minimal data entry during setup, the duplication module 1232D containing an electrical node set 1242D upon which a voltage configuration 1252D manifests a (first instance of) a user-switchable setting 1502 (a value that can switch only between “DO NOT REMIND” and “REMIND” as provided via client device 1000D, e.g.); and in which significantly more data entry would otherwise be required (starting from a fully acontextual template for each project e.g.). Execution then proceeds to execution block 1660.

Execution block 1660 depicts modifying the template with lane-specific or customer-specific filters. This can occur, for example, in a context in which (an instance of) an update module 1233B that performs this operation contains an electrical node set 1243B upon which a voltage configuration 1253B manifests a (first instance of) user input identifying a particular customer identifier 302 or a lane identifier 303 (or both). Update module 1233B implements the change and execution then proceeds to execution block 1665.

Execution block 1665 depicts allowing the user to adjust the current instance of the template, the standard instance of the template, or a filter by which one of the standard templates are adjusted. This can occur, for example, in a context in which (an instance of) an update module 1233C that performs this operation contains an electrical node set 1243C upon which a voltage configuration 1253C manifests input from the user expressing that adjustment. Update module 1233C implements the adjustment and execution then proceeds to execution block 1675.

Execution block 1675 depicts finalizing the reminder set. This can occur, for example, in a context in which (an instance of) an update module 1233D that performs this operation contains an electrical node set 1243D upon which a voltage configuration 1253D manifests an identifier of the saved shipping project. Update module 1233D implements the finalizing operation (by storing the semi-customized reminder set in memory 1104 accessible to execution circuitry 1526, e.g.) and execution then proceeds to decision block 1680.

At decision block 1680, if another shipping project is to be scheduled then execution passes back up to block 1610. Otherwise execution ends at block 1699. This can occur, for example, in a context in which an interface module 1231D that obtains this decision contains an electrical node set 1241D upon which a voltage configuration 1251D manifests a Boolean determination (based on user input, e.g.) or other such digital expression.

All of the patents and other publications referred to above are incorporated herein by reference generally—including those identified in relation to particular new applications of existing techniques—to the extent not inconsistent herewith. While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### CLAUSES

1. A computer-implemented method for scheduling transport-related events configurable by one or more users, the method comprising:

determining a current time (via timer 1334, e.g.);

responding to a first transport mode signaling a transport-by-boat shipment in association with a first transport project by providing a first task definition including a first action, a user- switchable first setting signifying by default that a reminder is to be sent concerning said first action, and a first reminder time signifying when said first action is to be done all identified by said first task definition 500 (see operations 1620 and 1625, e.g.);

automatically scheduling a reminder of said first action at a first reminder time partly based on said first task definition and partly based on said user-switchable first setting not having finally been toggled to a do-not-remind value (see FIGS. 8 and 9, e.g.);

automatically transmitting said reminder of said first action as a conditional response to said timer reaching said first reminder time partly based on not having received a notification that said first action is complete and partly based on said first reminder time signifying when said first action is to be done being unmodified such as by being toggled an even number of times (see FIG. 7, e.g.);

responding to a second transport mode signaling a transport-by-air shipment in association with a second transport project by providing a second task definition including a second action, a user-switchable second setting signifying by default that no reminder is to be sent concerning said second action, and a second reminder time signifying when said second action is to be done all identified by said second task definition 500 (see operations 1630, 1635, 1640, and 1645, e.g.);

automatically scheduling a reminder of said second action at a second reminder time partly based on said second task definition and partly based on one or more users having signaled that a reminder is to be sent concerning said second action by toggling said user-switchable second setting an odd number of times in response to user input (see FIGS. 10 and 11, e.g.); and

automatically transmitting said reminder of said second action as a conditional response to said timer reaching said second reminder time partly based on not having received a notification that said second action is complete and partly based on said second reminder time signifying when said second action is to be done being unmodified (see FIG. 7, e.g.).

2. The computer-implemented method of Method Clause 1, wherein said first task definition is a confirm-container-returned task definition, wherein said first action is a confirm-container-returned action, wherein said user-switchable first setting is a user-switchable reminder inclusion setting, and wherein said first reminder time is a confirm-container-returned reminder time (see record 840F of FIG. 8, e.g.).

3. The computer-implemented method of Method Clause 1, wherein said first task definition is not a confirm-container-returned task definition, wherein said first action is not a confirm-container-returned action, wherein said user-switchable first setting is a user-switchable reminder inclusion setting, and wherein said first reminder time is not a confirm-container-returned reminder time (see FIG. 8 generally, e.g.).

4. The computer-implemented method of ANY ONE of the above Method Clauses, wherein said second task definition is a confirm-re-ice-status task definition, wherein said second action is a confirm-re-ice-status action, wherein said user-switchable second setting is a user-switchable reminder inclusion setting, and wherein said second reminder time is a confirm-re-ice-status reminder time (see record 1040D of FIG. 10, e.g.).

5. The computer-implemented method of ANY ONE of the above Method Clauses 1-3, wherein said second task definition is not a confirm-re-ice-status task definition, wherein said second action is not a confirm-re-ice-status action, wherein said user-switchable second setting is a user-switchable reminder inclusion setting, and wherein said second reminder time is not a confirm-re-ice-status reminder time (see FIG. 10 generally, e.g.).

6. The computer-implemented method of ANY ONE of the above Method Clauses, the method further comprising

responding to said first transport mode signaling the transport-by-boat shipment in association with said first transport project by providing a third task definition including a third action, a user-switchable third setting signifying by default that no reminder is to be sent concerning said third action, and a third reminder time signifying when said third action is to be done all identified by said third task definition;

automatically scheduling a reminder of said third action at a third reminder time partly based on said third task definition and partly based on someone having signaled that a reminder is to be sent concerning said third action by toggling said user-switchable third setting;

automatically transmitting said reminder of said third action as a conditional response to said timer reaching said third reminder time partly based on not having received a notification that said third action is complete and partly based on said third reminder time signifying when said third action is to be done being unmodified (see record 940C of FIG. 9, e.g.).

7. The computer-implemented method of ANY ONE of the above Method Clauses, the method further comprising

responding to said second transport mode signaling the transport-by-air shipment in association with said second transport project by providing another task definition including another action, a user-switchable other setting signifying by default that that a reminder is to be sent concerning said other action, and another reminder time signifying when said other action is to be done all identified by said other task definition;

automatically scheduling a reminder of said other action at another reminder time partly based on said other task definition and partly based on said user-switchable first setting not having finally been toggled to a do-not-remind value; and

automatically transmitting said reminder of said other action as a conditional response to said timer reaching said other reminder time partly based on not having received a notification that said other action is complete and partly based on said other reminder time signifying when said other action is to be done being unmodified (see the “IS CUSTOMS CLEARED?” record of FIG. 11, e.g.).

8. A system comprising:

transistor-based circuitry configured to perform ANY ONE of the above Method Clauses.

With respect to the numbered claims expressed below, those skilled in the art will appreciate that recited operations therein may generally be performed in any order. Also, although various operational flows are presented in sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1-4. (canceled)

5. A computer-implemented method for scheduling transport-related events configurable by one or more users, the method comprising:
invoking a timer configured to maintain a current time;
invoking transistor-based circuitry configured to respond to a first transport mode signaling a transport-by-boat shipment in association with a first transport project by configuring a generic transport-by-boat reminder template with multiple set reminders each associating a respective transport-by-boat action with both a respective user-switchable transport-by-boat positive setting signifying by default that a transport-by-boat reminder message is to be sent concerning said transport-by-boat action and a respective transport-by-boat default reminder time signifying when said transport-by-boat reminder message is to be sent concerning said transport-by-boat action all simultaneously depicted within a first display screen image, wherein said transport-by-boat reminder template is also configured with multiple not-set reminders each associating a respective transport-by-boat action with both a respective user-switchable transport-by-boat negative setting signifying by default that no reminder message is to be sent concerning said transport-by-boat action and a respective transport-by-boat default reminder time all simultaneously depicted within said first display screen image;
automatically invoking transistor-based circuitry configured to schedule a reminder of a first one of the transport-by-boat actions at a first one of the transport-by-boat reminder times partly based on a first transport-by-boat task definition and partly based on a first one of the user-switchable transport-by-boat positive settings not having finally been toggled to a do-not-remind value;
automatically invoking transistor-based circuitry configured to transmit said reminder of said first transport-by-boat action as a conditional response to said timer reaching said first transport-by-boat reminder time partly based on not having received a notification that said first transport-by-boat action is complete and partly based on said first transport-by-boat reminder time signifying when said reminder of said first transport-by-boat action is to be done being unmodified;
invoking transistor-based circuitry configured to respond to a second transport mode signaling a transport-by-air-import shipment in association with a second transport project by configuring a generic transport-by-air-import reminder template with multiple set reminders each associating a respective transport-by-air-import action with both a respective user-switchable transport-by-air-import positive setting signifying by default that a transport-by-air-import reminder message is to be sent concerning said transport-by-air-import action and a respective transport-by-air-import default reminder time signifying when said transport-by-air-import reminder message is to be sent concerning said transport-by-air-import action all simultaneously depicted within a second display screen image, wherein said transport-by-air-import reminder template is also configured with multiple not-set reminders each associating a respective transport-by-air-import action with both a respective user-switchable transport-by-air-import negative setting signifying by default that no reminder message is to be sent concerning said transport-by-air-import action and a respective transport-by-air-import default reminder time all simultaneously depicted within said second display screen image;
automatically invoking transistor-based circuitry configured to schedule a reminder of a first one of said transport-by-air-import actions at a first one of said transport-by-air-import reminder times partly based on a first transport-by-air-import task definition and partly based on said one or more users having activated said reminder of said first transport-by-air-import action by toggling a first one of the user-switchable transport-by-air-import negative settings;
automatically invoking transistor-based circuitry configured to transmit said reminder of said first transport-by-air-import action as a conditional response to said timer reaching said first transport-by-air-import reminder time partly based on not having received a notification that said first transport-by-air-import action is complete and partly based on said first transport-by-air-import reminder time signifying when said reminder of said first transport-by-air-import action is to be done being unmodified;
invoking transistor-based circuitry configured to respond to a third transport mode signaling a transport-by-air-export shipment in association with a third transport project by configuring a generic transport-by-air-export reminder template with multiple set reminders each associating a respective transport-by-air-export action with both a respective user-switchable transport-by-air-export positive setting signifying by default that a transport-by-air-export reminder message is to be sent concerning said transport-by-air-export action and a respective transport-by-air-export default reminder time signifying when said transport-by-air-export reminder message is to be sent concerning said transport-by-air-export action all simultaneously depicted within a third display screen image, wherein said transport-by-air-export reminder template is also configured with multiple not-set reminders each associating a respective transport-by-air-export action with both a respective user-switchable transport-by-air-export negative setting signifying by default that no reminder message is to be sent concerning said transport-by-air-export action and a respective transport-by-air-export default reminder time all simultaneously depicted within said third display screen image; and
automatically invoking transistor-based circuitry configured to schedule a not-set reminder of a first one of the transport-by-air-export actions at a first one of the transport-by-air-export reminder times partly based on a first transport-by-air-export task definition and partly based on said reminder of said first transport-by-air-export action not having been toggled finally to become an other transport-by-air-export negative setting.

6-9. (canceled)

10. The computer-implemented method of claim 5, further comprising:
automatically invoking transistor-based circuitry configured to schedule a reminder of a second one of the transport-by-boat actions at a second one of the transport-by-boat reminder times partly based on a respective transport-by-boat task definition and partly based on one of the user-switchable transport-by-boat negative settings having finally been toggled to a do-remind value concerning a confirmation that a credit/debit note has been received;
automatically invoking transistor-based circuitry configured to transmit said reminder of said second transport-by-boat action as a conditional response to said timer reaching said second transport-by-boat reminder time partly based on not having received a notification that said second transport-by-boat action is complete and partly based on said second transport-by-boat reminder time signifying when said reminder of said second transport-by-boat action is to be done being unmodified;
automatically invoking transistor-based circuitry configured to schedule a reminder of a third one of the transport-by-boat actions at a third one of the transport-by-boat reminder times partly based on a respective transport-by-boat task definition and partly based on one of the user-switchable transport-by-boat negative settings having finally been toggled to a do-remind value concerning a confirmation that cargo has arrived at a trans-shipment point;
automatically invoking transistor-based circuitry configured to transmit said reminder of said third transport-by-boat action as a conditional response to said timer reaching said third transport-by-boat reminder time partly based on not having received a notification that said third transport-by-boat action is complete and partly based on said third transport-by-boat reminder time signifying when said reminder of said third transport-by-boat action is to be done being unmodified;
automatically invoking transistor-based circuitry configured to schedule a reminder of a fourth one of the transport-by-boat actions at a fourth one of the transport-by-boat reminder times partly based on a respective transport-by-boat task definition and partly based on one of the user-switchable transport-by-boat negative settings having finally been toggled to a do-remind value concerning a confirmation that a Master Bill of Lading (MBL) has been consigned;
automatically invoking transistor-based circuitry configured to transmit said reminder of said fourth transport-by-boat action as a conditional response to said timer reaching said fourth transport-by-boat reminder time partly based on not having received a notification that said fourth transport-by-boat action is complete and partly based on said fourth transport-by-boat reminder time signifying when said reminder of said fourth transport-by-boat action is to be done being unmodified;
automatically invoking transistor-based circuitry configured to schedule a reminder of a fifth one of the transport-by-boat actions at a fifth one of the transport-by-boat reminder times partly based on a respective transport-by-boat task definition and partly based on one of the user-switchable transport-by-boat negative settings having finally been toggled to a do-remind value concerning a confirmation that a final destination Estimated Time of Arrival (ETA) has been confirmed;
automatically invoking transistor-based circuitry configured to transmit said reminder of said fifth transport-by-boat action as a conditional response to said timer reaching said fifth transport-by-boat reminder time partly based on not having received a notification that said fifth transport-by-boat action is complete and partly based on said fifth transport-by-boat reminder time signifying when said reminder of said fifth transport-by-boat action is to be done being unmodified;
automatically invoking transistor-based circuitry configured to schedule a reminder of a sixth one of the transport-by-boat actions at a sixth one of the transport-by-boat reminder times partly based on a respective transport-by-boat task definition and partly based on one of the user-switchable transport-by-boat negative settings having finally been toggled to a do-remind value concerning a confirmation that a delivery is pending;
automatically invoking transistor-based circuitry configured to transmit said reminder of said sixth transport-by-boat action as a conditional response to said timer reaching said sixth transport-by-boat reminder time partly based on not having received a notification that said sixth transport-by-boat action is complete and partly based on said sixth transport-by-boat reminder time signifying when said reminder of said sixth transport-by-boat action is to be done being unmodified;
automatically invoking transistor-based circuitry configured to schedule a reminder of a seventh one of the transport-by-boat actions at a seventh one of the transport-by-boat reminder times partly based on a respective transport-by-boat task definition and partly based on one of the user-switchable transport-by-boat negative settings having finally been toggled to a do-remind value concerning a confirmation that one or more shipping containers have been returned; and
automatically invoking transistor-based circuitry configured to transmit said reminder of said seventh transport-by-boat action as a conditional response to said timer reaching said seventh transport-by-boat reminder time partly based on not having received a notification that said seventh transport-by-boat action is complete and partly based on said seventh transport-by-boat reminder time signifying when said reminder of said seventh transport-by-boat action is to be done being unmodified.

11. The computer-implemented method of claim 10, wherein said automatically invoking transistor-based circuitry configured to transmit said reminder of said first transport-by-boat action comprises:
upon said timer completing a programmatic booking-confirmed-reminder delay and after receiving an estimated time of arrival (ETA), a server automatically transmitting said reminder of said first transport-by-boat action indicating when a booking needs to be confirmed partly based on not having received any notification that said first transport-by-boat action is complete and partly based on said first transport-by-boat reminder time signifying when said reminder of said first transport-by-boat action is to be done being unmodified, wherein said first transport-by-boat action is a booking-confirmed action and wherein said reminder of said first transport-by-boat action is a booking-confirmed reminder and is a first one of said multiple set reminders,
upon said timer completing a programmatic shipment-confirmed-on-board-reminder delay and after having automatically transmitted said booking-confirmed reminder, said server automatically transmitting a shipment-confirmed-on-board reminder indicating when said shipment needs to be confirmed on board, wherein said shipment-confirmed-on-board reminder is a second one of said multiple set reminders;
upon said timer completing a programmatic Master Bill of Lading (MBL) receipt-confirmation-reminder delay and after having automatically transmitted said shipment-confirmed-on-board reminder, said server automatically transmitting a MBL-receipt-confirmation reminder, wherein said MBL-receipt-confirmation reminder is a third one of said multiple set reminders; and
upon said timer completing a regulatory-hold-confirmation-reminder delay and after having automatically transmitted said MBL-receipt-confirmation reminder, said server automatically transmitting a regulatory-hold-confirmation reminder, wherein said regulatory-hold-confirmation reminder is a fourth one of said multiple set reminders.

12. The computer-implemented method of claim 10, further comprising:
enabling said one or more users to create a customized transport-by-boat reminder template merely by toggling one or more of the user-switchable transport-by-boat negative settings in an instance of said generic transport-by-boat reminder template and by storing a transport-by-boat reminder set resulting therefrom finalized as a component of said first transport project.

13. The computer-implemented method of claim 12, further comprising:
enabling said one or more users to create a customized transport-by-air-import reminder template merely by toggling one or more of said user-switchable transport-by-air-import positive settings in an instance of said generic transport-by-air-import reminder template and by storing a transport-by-boat reminder set resulting therefrom finalized as a component of said second transport project.

14. The computer-implemented method of claim 13, further comprising:
enabling said one or more users to create a customized transport-by-air-export reminder template merely by toggling one or more of said user-switchable transport-by-air-export positive settings in an instance of said generic transport-by-air-export reminder template and by storing a transport-by-boat reminder set resulting therefrom finalized as a component of said third transport project.

15. The computer-implemented method of claim 5, wherein said automatically invoking transistor-based circuitry configured to transmit said reminder of said first transport-by-boat action comprises:
upon said timer completing a programmatic booking-confirmed-reminder delay and after receiving an estimated time of arrival (ETA), a server automatically transmitting said reminder of said first transport-by-boat action indicating when a booking needs to be confirmed partly based on not having received any notification that said first transport-by-boat action is complete and partly based on said first transport-by-boat reminder time signifying when said reminder of said first transport-by-boat action is to be done being unmodified, wherein said first transport-by-boat action is a booking-confirmed action and wherein said reminder of said first transport-by-boat action is a booking-confirmed reminder and is a first one of said multiple set reminders,
upon said timer completing a programmatic shipment-confirmed-on-board-reminder delay and after having automatically transmitted said booking-confirmed reminder, said server automatically transmitting a shipment-confirmed-on-board reminder indicating when said shipment needs to be confirmed on board, wherein said shipment-confirmed-on-board reminder is a second one of said multiple set reminders;
upon said timer completing a programmatic Master Bill of Lading (MBL) receipt-confirmation-reminder delay and after having automatically transmitted said shipment-confirmed-on-board reminder, said server automatically transmitting a MBL-receipt-confirmation reminder, wherein said MBL-receipt-confirmation reminder is a third one of said multiple set reminders; and
upon said timer completing a regulatory-hold-confirmation-reminder delay and after having automatically transmitted said MBL-receipt-confirmation reminder, said server automatically transmitting a regulatory-hold-confirmation reminder, wherein said regulatory-hold-confirmation reminder is a fourth one of said multiple set reminders.

16. The computer-implemented method of claim 15, wherein said server automatically transmitting said shipment-confirmed-on-board reminder comprises:
transmitting said shipment-confirmed-on-board reminder indicating when said shipment needs to be confirmed on board a ship that is scheduled to cross an ocean.

17. The computer-implemented method of claim 5, further comprising:
automatically invoking transistor-based circuitry configured to schedule a reminder of an other one of the transport-by-boat actions at an other one of the transport-by-boat reminder times partly based on an other transport-by-boat task definition and partly based on one of the user-switchable transport-by-boat negative settings having finally been toggled to a do-remind value concerning a confirmation that cargo has arrived at a trans-shipment point; and
automatically invoking transistor-based circuitry configured to transmit said reminder of said other transport-by-boat action as a conditional response to said timer reaching said other transport-by-boat reminder time partly based on not having received a notification that said other transport-by-boat action is complete and partly based on said other transport-by-boat reminder time signifying when said reminder of said other transport-by-boat action is to be done being unmodified.

18. The computer-implemented method of claim 5, further comprising:
automatically invoking transistor-based circuitry configured to schedule a reminder of an other one of the transport-by-boat actions at an other one of the transport-by-boat reminder times partly based on an other transport-by-boat task definition and partly based on one of the user-switchable transport-by-boat negative settings having finally been toggled to a do-remind value concerning a confirmation that a Master Bill of Lading (MBL) has been consigned; and
automatically invoking transistor-based circuitry configured to transmit said reminder of said other transport-by-boat action as a conditional response to said timer reaching said other transport-by-boat reminder time partly based on not having received a notification that said other transport-by-boat action is complete and partly based on said other transport-by-boat reminder time signifying when said reminder of said other transport-by-boat action is to be done being unmodified.

19. The computer-implemented method of claim 5, further comprising:
automatically invoking transistor-based circuitry configured to schedule a reminder of a second one of the transport-by-boat actions at a second one of the transport-by-boat reminder times partly based on a second transport-by-boat task definition and partly based on one of the user-switchable transport-by-boat negative settings having finally been toggled to a do-remind value concerning a confirmation that a final destination Estimated Time of Arrival (ETA) has been confirmed; and
automatically invoking transistor-based circuitry configured to transmit said reminder of said second transport-by-boat action as a conditional response to said timer reaching said second transport-by-boat reminder time partly based on not having received a notification that said second transport-by-boat action is complete and partly based on said second transport-by-boat reminder time signifying when said reminder of said second transport-by-boat action is to be done being unmodified.

20. The computer-implemented method of claim 5, further comprising:
automatically invoking transistor-based circuitry configured to schedule a reminder of a second one of the transport-by-boat actions at a second one of the transport-by-boat reminder times partly based on a second transport-by-boat task definition and partly based on one of the user-switchable transport-by-boat negative settings having finally been toggled to a do-remind value concerning a confirmation that a delivery is pending; and
automatically invoking transistor-based circuitry configured to transmit said reminder of said second transport-by-boat action as a conditional response to said timer reaching said second transport-by-boat reminder time partly based on not having received a notification that said second transport-by-boat action is complete and partly based on said second transport-by-boat reminder time signifying when said reminder of said second transport-by-boat action is to be done being unmodified.

21. The computer-implemented method of claim 5, further comprising:
automatically invoking transistor-based circuitry configured to schedule a reminder of a second one of the transport-by-boat actions at a second one of the transport-by-boat reminder times partly based on a second transport-by-boat task definition and partly based on one of the user-switchable transport-by-boat negative settings having finally been toggled to a do-remind value concerning a confirmation that one or more shipping containers have been returned; and
automatically invoking transistor-based circuitry configured to transmit said reminder of said second transport-by-boat action as a conditional response to said timer reaching said second transport-by-boat reminder time partly based on not having received a notification that said second transport-by-boat action is complete and partly based on said second transport-by-boat reminder time signifying when said reminder of said second transport-by-boat action is to be done being unmodified.

22. The computer-implemented method of claim 5, further comprising:
enabling said one or more users to create a customized transport-by-boat reminder template merely by toggling one or more of the user-switchable transport-by-boat negative settings in an instance of said generic transport-by-boat reminder template and by storing a transport-by-boat reminder set resulting therefrom finalized as a component of said first transport project.

23. The computer-implemented method of claim 5, further comprising:
enabling said one or more users to create a customized transport-by-air-import reminder template merely by toggling one or more of said user-switchable transport-by-air-import positive settings in an instance of said generic transport-by-air-import reminder template and by storing a transport-by-air-import reminder set resulting therefrom finalized as a component of said second transport project.

24. The computer-implemented method of claim 5, further comprising:
enabling said one or more users to create a customized transport-by-air-export reminder template merely by toggling one or more of said user-switchable transport-by-air-export positive settings in an instance of said generic transport-by-air-export reminder template and by storing a transport-by-air-export reminder set resulting therefrom finalized as a component of said third transport project.

25. The computer-implemented method of claim 5, further comprising:
enabling said one or more users to create a customized reminder template merely by toggling one or more of the user-switchable settings and by storing a reminder set resulting therefrom finalized as a component of said first, second, or third transport project.

26. The computer-implemented method of claim 5, wherein all of said first, second, and third transport projects are finalized in response to input from a scheduling agent before any of said transistor-based circuitry configured to transmit is invoked and wherein no recipient of any of said reminders has access to said scheduling agent thereafter.
